(19) United States
(12) Patent Application Publication
(10) Pub. No.: US 2014/0122576 A1
(43) Pub. Date: May 1, 2014

(54) SETTING SUPPORT APPARATUS, SETTING SUPPORT SYSTEM AND SETTING SUPPORT METHOD

(71) Applicants: Hideharu OHKUMA, Tokyo (JP); Sachiko TAKEUCHI, Tokyo (JP)

(72) Inventors: Hideharu OHKUMA, Tokyo (JP); Sachiko TAKEUCHI, Tokyo (JP)

(73) Assignee: Ricoh Company, Ltd., Tokyo (JP)

(21) Appl. No.: 14/059,560

(22) Filed: Oct. 22, 2013

(30) Foreign Application Priority Data
Oct. 26, 2012 (JP) 2012-236408
Oct. 2, 2013 (JP) 2013-207071

(51) Int. Cl. H04L 29/06

(52) U.S. Cl. CPC H04L 67/42
USPC 709/203

(57) ABSTRACT

A setting support apparatus includes an obtaining part configured to obtain, in response to an input request to input a value for a setting item of a program, the program identification information of the program stored in correlation with identification information pertaining to a requestor of the input request in a first storage part, a generation part configured to generate data for causing the value to be input for the setting item of the program related to the obtained program identification information, and a returning part configured to return the generated data to the requestor of the input request.

### CROSS-REFERENCE TO RELATED APPLICATIONS

The present application is based upon and claims the benefit of priority of Japanese Patent Application No. 2012-236408, filed on Oct. 26, 2012, and No. 2013-207071, filed on Oct. 2, 2013, the entire contents of which are incorporated herein by reference.

### BACKGROUND OF THE INVENTION

1. Field of the Invention

The present invention relates to setting support apparatuses, setting support systems and setting support methods.

2. Description of the Related Art

For example, in services provided via a network, such as cloud services, multiple application programs may be used. Such application programs are shared by multiple users. Accordingly, each application program has settings (setting items) for enabling the provision of services according to the users. Each user is required to set values corresponding to the user with respect to the setting items.

Reference may be made to Japanese Laid-Open Patent Application No. 2000-285077 for a related technique.

### SUMMARY OF THE INVENTION

According to an aspect of the present invention, a setting support apparatus includes an obtaining part configured to obtain, in response to an input request to input a value for a setting item of a program, program identification information of the program stored in correlation with identification information pertaining to a requestor of the input request in a first storage part; a generation part configured to generate data for causing the value to be input for the setting item of the program related to the obtained program identification information; and a returning part configured to return the generated data to the requestor of the input request.

According to an aspect of the present invention, a setting support system, which includes a computer, includes an obtaining part configured to obtain, in response to an input request to input a value for a setting item of a program, program identification information of the program stored in correlation with identification information pertaining to a requestor of the input request in a first storage part; a generation part configured to generate data for causing the value to be input for the setting item of the program related to the obtained program identification information; and a returning part configured to return the generated data to the requestor of the input request.

According to an aspect of the present invention, a setting support method includes obtaining, by a computer, in response to an input request to input a value for a setting item of a program, program identification information of the program stored in correlation with identification information pertaining to a requestor of the input request in a first storage part; generating, by the computer, data for causing the value to be input for the setting item of the program related to the obtained program identification information; and returning, by the computer, the generated data to the requestor of the input request.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a configuration of an information processing system according to a first embodiment;

FIG. 2 is a diagram illustrating a hardware configuration of a service providing apparatus according to the first embodiment;

FIG. 3 is a diagram illustrating a functional configuration of a service providing apparatus according to the first embodiment;

FIG. 4 is a flowchart for illustrating a procedure for a process of generating setting data executed by a service providing apparatus according to the first embodiment;

FIG. 5 is a diagram illustrating a configuration of a purchased application information storage part according to the first embodiment;

FIG. 6 is a diagram illustrating a configuration of a proper setting item information storage part according to the first embodiment;

FIG. 7 is a diagram illustrating a configuration of a proper setting item information storage part in JSON format according to the first embodiment;

FIG. 8 is a diagram illustrating a configuration of a user information storage part according to the first embodiment;

FIG. 9 is a diagram illustrating an example of a CSV file as setting data according to the first embodiment;

FIG. 10 is a flowchart for illustrating a procedure for a process of setting setting values for common setting items and proper setting items according to the first embodiment;

FIG. 11 is a diagram illustrating a process of setting setting values by a setting recording part according to the first embodiment;

FIG. 12 is a diagram illustrating a functional configuration of a service providing apparatus according to a second embodiment;

FIG. 13 is a diagram illustrating example display of a setting screen according to the second embodiment;

FIG. 14 is a diagram illustrating first example display of a setting screen, where the common setting items and individual server applications are assigned respective tabs, according to the second embodiment;

FIG. 15 is a diagram illustrating second example display of the setting screen, where the common setting items and individual server applications are assigned respective tabs, according to the second embodiment;

FIG. 16 is a diagram illustrating third example display of the setting screen, where the common setting items and individual server applications are assigned respective tabs, according to the second embodiment;

FIG. 17 is a diagram illustrating a functional configuration of a service providing apparatus according to a third embodiment; and

FIG. 18 is a diagram illustrating an example of the plugging of portlets into a portal application according to the third embodiment.

### DETAILED DESCRIPTION OF THE PREFERRED EMBODIMENTS

It is a large operational load for a user to have a setting screen displayed for each application program and set values for setting items from application program to application program.

According to an aspect of the present invention, the operational load of setting values for the setting items of a program is reduced.

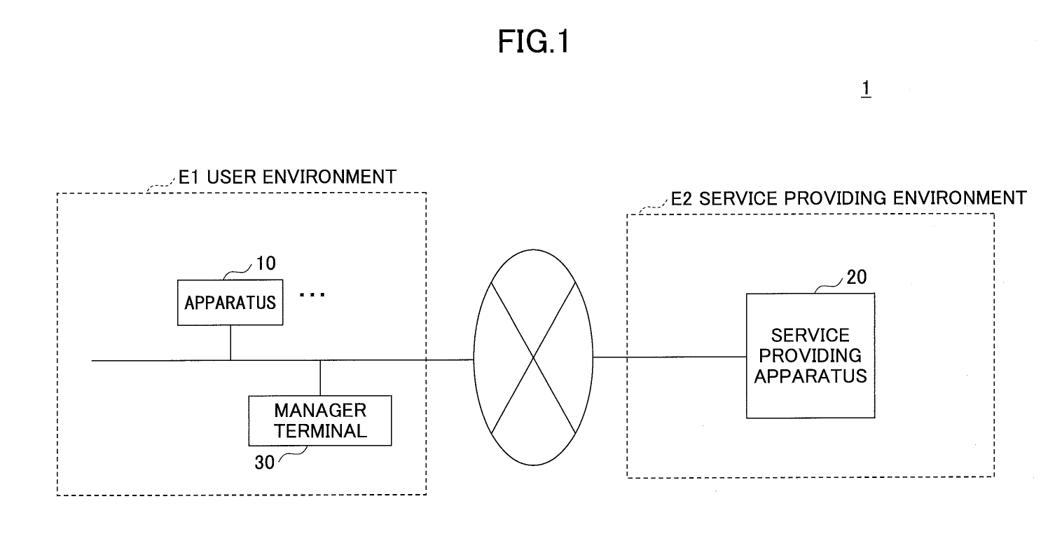

A description is given below, with reference to the accompanying drawings, of embodiments of the present invention. FIG. 1 is a diagram illustrating a configuration of an information processing system according to a first embodiment. Referring to FIG. 1, the information processing system 1 includes a user environment E1 and a service providing environment E2, which may communicate with each other via a wide area network such as the Internet.

The service providing environment E2 is a system environment in an organization that provides cloud services via a network. In this embodiment, cloud services are described by way of example, but this embodiment may also be applied to services provided via a network, such as services provided by application service provider (ASP)s and Web services.

The service providing environment E2 includes a service providing apparatus 20. The user environment E1 includes one or more apparatuses 10, which may be hereinafter collectively referred to as “apparatus 10”. The service providing apparatus 20 provides a predetermined service via a network. One form of the service provided by the service providing apparatus is a service achieved by causing the apparatus 10 in the user environment E1 to cooperate with an application in the service providing apparatus 20. Hereinafter, such a form of service is referred to as “apparatus cooperation service.” One example of apparatus cooperation services is the service that an application in the service providing apparatus 20 stores image data scanned in the apparatus 10 of the user environment E1 in a preset storage destination (hereinafter referred to as “scan-to-storage service”). Other examples of apparatus cooperation services include the service of transmitting output data such as print data and image data managed by an application in the service providing apparatus 20 to the apparatus 10 of the user environment E1 and printing out the output data in the apparatus 10 (hereinafter referred to as “print service”) or displaying (projecting) the output data in the apparatus 10 (hereinafter referred to as “projection service”). The apparatus cooperation service may include cooperation with an online storage or other cloud services provided via a network by service providers other than the service providing environment E2.

The user environment E1 is a system environment in an organization such as a corporation that uses the apparatus 10. In the user environment E1, the apparatus 10 and a manager terminal 30 are connected via a network such as a local area network (LAN).

The apparatus 10 serves as a cooperation candidate of the apparatus cooperation service. The manager terminal 30 is a terminal used by a manager of the apparatus 10 in the user environment E1. Examples of the manager terminal 30 include a personal computer (PC), a personal digital assistant (PDA), a tablet terminal, a smartphone, and a cellular phone.

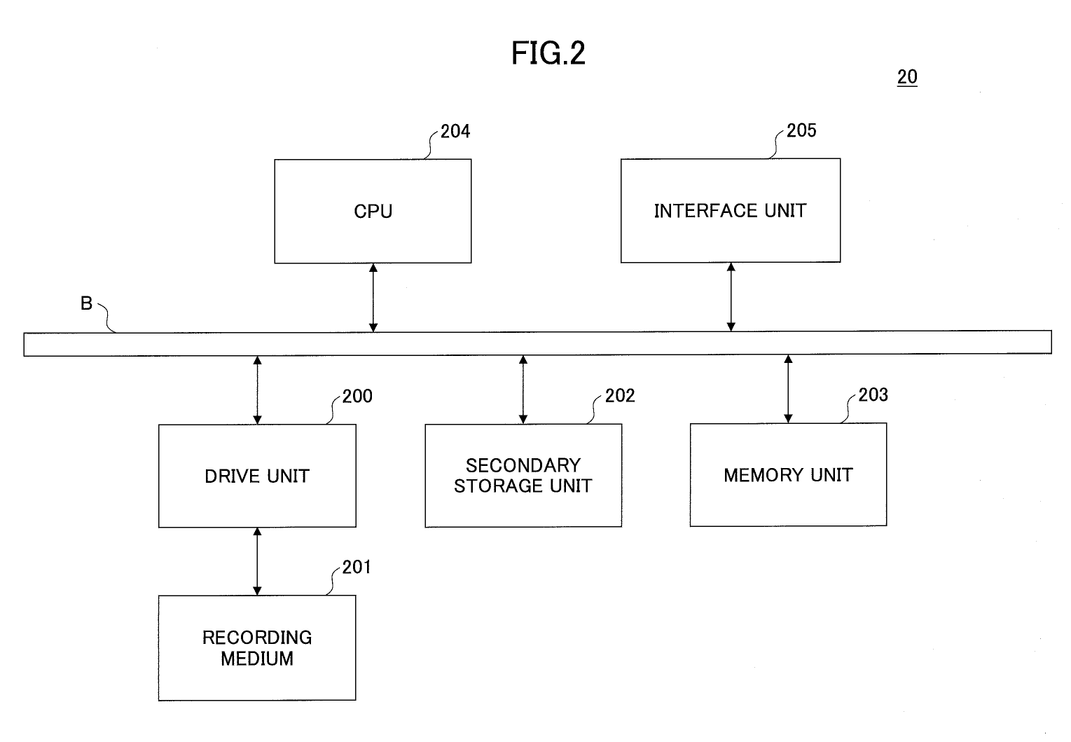

FIG. 2 is a diagram illustrating a hardware configuration of a service providing apparatus according to the first embodiment. Referring to FIG. 2, the service providing apparatus 20 includes a drive unit 200, a secondary storage unit 202, a memory unit 203, a central processing unit (CPU) 204, and an interface (I/F) unit 205, all of which are interconnected by a bus B.

A program that implements processes in the service providing apparatus 20 is provided by way of a recording medium 201 such as a CD-ROM. When the recording medium 201 storing a program is loaded into the drive unit 200, the program is installed in the secondary storage unit 202 from the recording medium 201 via the drive unit 200. A program, however, does not necessary have to be installed from the recording medium 201, and may be downloaded from other computers via a network. The secondary storage unit 202 stores not only installed programs but also files and data.

The memory unit 203 reads a program from the secondary storage unit 202 and stores the read program in response to an instruction to activate the program. The CPU 204 executes a function pertaining to the service providing apparatus 20 in accordance with a program stored in the memory unit 203. The interface unit 205 is used as an interface for connecting a network.

The service providing apparatus 20 may be formed of multiple computers each having the hardware as illustrated in FIG. 2. That is, the processes executed by the service providing apparatus 20 in the following description may be distributed among and executed by multiple computers. The service providing apparatus 20 may be formed of one or more computers.

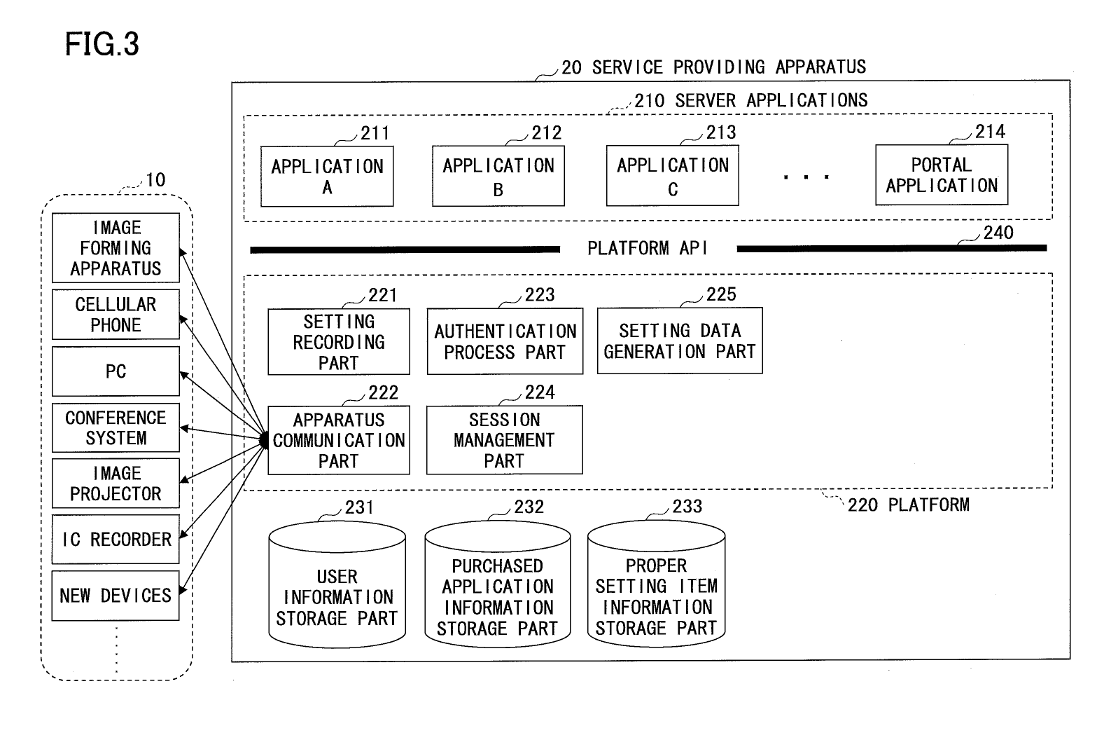

FIG. 3 is a diagram illustrating a functional configuration of a service providing apparatus according to the first embodiment. Referring to FIG. 3, the service providing apparatus 20 includes software including server applications 210 and a platform 220, which are composed of one or more programs installed in the service providing apparatus 20 and cause the CPU 204 to execute predetermined processes.

The service providing apparatus 20 uses a user information storage part 231, a purchased application information storage part 232, and a proper setting item information storage part 233. These storage parts 231 through 233 may be implemented using the secondary storage unit 202 or a storage unit connected to the service providing apparatus 20 via a network.

The server applications 210 are application programs that implement apparatus cooperation services provided by the service providing apparatus 20. Basically, there is a one-to-one correspondence between the server applications 210 and apparatus cooperation services. Accordingly, a license for an apparatus cooperation service may be considered as a license for one of the server applications 210 pertaining to the apparatus cooperation service. Referring to FIG. 3, an application A 211, an application B 212, an application C 213, and a portal application 214 are illustrated as examples of the server applications 210. According to this embodiment, the functions of the application A 211, the application B 212, and the application C 213 are not limited in particular. For example, the application A 211 may be one of the server applications 210 that implements a scan-to-storage service.

The application A 211, the application B 212, and the application C 213 provide respective services using functions of the platform 220 by utilizing a platform application program interface (API) 240. Accordingly, each of the server applications 210 may use user information stored in the user information storage part 231, for example. Furthermore, each of the application A 211, the application B 212, and the application C 213 individually has one or more setting items or has one or more setting items proper thereto as required. Hereinafter, these setting items are referred to as “proper setting items.” For the proper setting items of each of the application A 211, the application B 212, and the application C 213, values may be set with respect to each user (from user to user), for example. That is, the application A 211, the application B 212, and the application C 213 may be implemented as application programs that implement respective services by executing processes according to users based on the values set in their respective proper setting items user by user in addition to the user information stored in the user information storage part 231. The portal application 214 is one of the server applications 210 that provides a portal site with respect to the service providing apparatus 20.

The platform 220 includes functions common to the server applications 210 or basic functions used by the server applications 210. Referring to FIG. 3, the platform 220 includes a setting recording part 221, an apparatus communication part 222, an authentication process part 223, a session management part 224, and a setting data generation part 225. The functions of these parts 221 through 225 are open to the server applications 210 via the platform API 240. In other words, the server applications 210 may use the functions of these parts 221 through 225 as far as the functions are made open by the platform API 240.

The user information storage part 231 stores user information, that is, information on users of services provided by the service providing apparatus 20.

The setting recording part 221 sets and records information on the user environment E1 that is required prior to use of apparatus cooperation services. The setting recording part 221 records information in the user information storage part 231. The setting recording part 221 sets setting values for the proper setting items of each of the server applications 210. The user information stored in the user information storage part 231 may be shared by the platform 220 and the server applications 210. Therefore, the setting items of the user information stored in the user information storage part 231 are referred to as “common setting items” in contrast to the proper setting items. The proper setting items of one of the individual server application 210 may include one or more of the common setting items or one or more items that are included in the proper setting items of another one of the server applications 210.

The setting data generation part 225 generates data for causing a user to set setting values for the common setting items and the proper setting items (hereinafter referred to as “setting data”).

The apparatus communication part 222 controls communications with the apparatus 10. The authentication process part 223 authenticates a user of the manager terminal 30 or a user of the apparatus 10. The session management part 224 manages sessions of communications between the service providing apparatus 20 and the apparatus 10 when the service providing apparatus 20 and the apparatus 10 cooperate with each other.

In FIG. 3, an image forming apparatus such as a multifunction machine, a copier, a facsimile machine or a printer, a cellular phone, a PC, a conference system, an image projector, an IC recorder, and other new devices that use apparatus cooperation services are illustrated as examples of the apparatus 10.

For example, the server applications 210 may use respective different computers, the parts 221 through 225 of the platform 220 may use respective different computers, and the storage parts 231 through 233 may use respective different computers. In this case, the computers may be interconnected via a network so as to be able to communicate with one another.

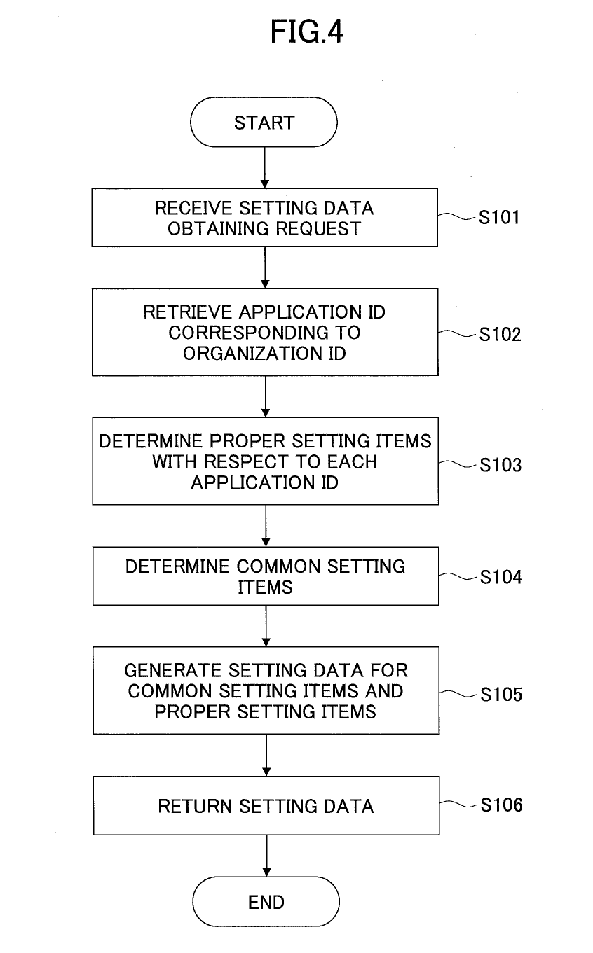

A description is given below of procedures for processes executed in the information processing system 1. FIG. 4 is a flowchart for illustrating a procedure for a process of generating setting data executed by a service providing apparatus according to the first embodiment.

Referring to FIG. 4, at step S101, the setting data generation part 225 of the service providing apparatus 20 receives a request to obtain (for example, a request to download) setting data (a setting data obtaining request). The setting data obtaining request is an example of a request to input values for setting items. The setting data obtaining request is transmitted from, for example, the manager terminal 30. Identification information that identifies the user environment E1 to which the manager terminal 30 belongs is specified in the setting data obtaining request. According to this embodiment, an organization ID, which is identification information that identifies an organization as a user, is used as the identification information of a user. The organization ID may be an ID assigned corporation by corporation or section by section in a corporation. Furthermore, the organization ID may be assigned to not only definite organizations but also a group of multiple users. Furthermore, in the case of setting values for setting items with respect to each individual user, the organization ID may be replaced with the identification information of each individual user, such as a user ID, or the organization ID may be correlated with a user ID and used as the identification information of each individual user. That is, the unit of a “user” may be suitably selected or determined in accordance with operations.

Next, at step S102, the setting data generation part 225 retrieves or obtains, from the purchased application information storage part 232, the identification information of one or more of the server applications 210 (hereinafter referred to as “application ID(s)”) available to an organization related to the organization ID specified in the setting data obtaining request (hereinafter referred to as “target organization ID”).

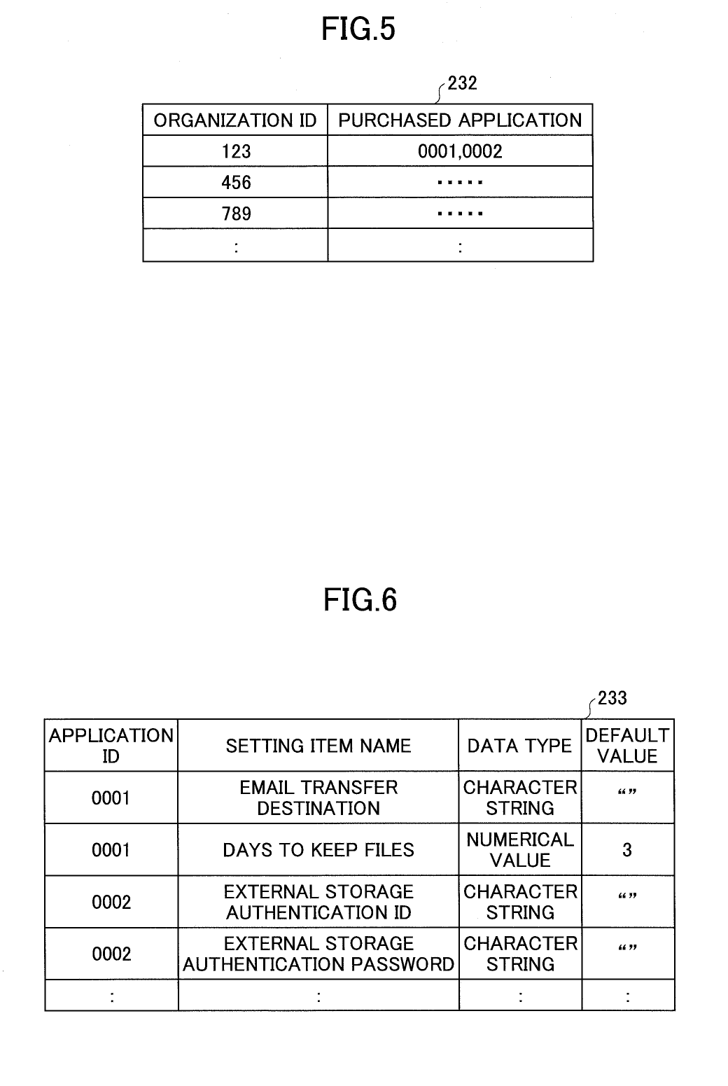

FIG. 5 is a diagram illustrating a configuration of a purchased application information storage part. Referring to FIG. 5, the purchased application information storage part 232 stores, in correlation with an organization ID, the application ID of one or more of the server applications 210 for which a user related to the organization ID has purchased a license. For example, FIG. 5 shows that a user whose organization ID is “123” has purchased a license for a server application 210 whose application ID is “0001” and a server application 210 whose application ID is “0002.” Here, the license refers to the authority to use a server application 210. Furthermore, in this embodiment, it is assumed that the server application 210 whose application ID is “0001” is the server application A 211 and the server application 210 whose application ID is “0002” is the server application B 212.

At step S102, a list of one or more application IDs correlated with the target organization ID is obtained.

Next, at step S103, the setting data generation part 225 refers to the proper setting item information storage part 233, and determines or specifies proper setting items with respect to each retrieved application ID.

FIG. 6 is a diagram illustrating a configuration of a proper setting item information storage part. Referring to FIG. 6, the proper setting item information storage part 233 stores, in correlation with an application ID, the names (setting item names), data types, default values, etc., of the proper setting items of a server application 210 related to the application ID. In the example of FIG. 6, it is illustrated that “email transfer destination” and “days to keep files” are the proper setting items of the application A 211, whose application ID is “0001.” Furthermore, it is illustrated that “external storage authentication ID” and “external storage authentication password” are the proper setting items of the application B 212, whose application ID is “0002.”

At step S103, with respect to each retrieved application ID, one or more setting item names stored in correlation with the application ID in the proper setting item information storage part 233 are obtained.

The information stored in the proper setting item information storage part 233 may be recorded in the proper setting item information storage part 233 using the setting recording part 221 by a server application 210 with the installation of the server application 210, for example. For example, at the time of the installation of the server application A 211, the server application A 211 or an installer for the server application A 211 may record information on the proper setting items of the server application A 211 in the proper setting item information storage part 233. Furthermore, the information stored in the proper setting item information storage part 233 may be recorded at the time of the upgrading of the server application 210, for example. Furthermore, the setting recording part 221 may periodically request to obtain information on the proper setting items from the server application 210 and record the obtained information.

Furthermore, the proper setting item information storage part 233 may not be in table format. For example, the proper setting item information storage part 233 may in JavaScript (registered trademark) Objection Notation (JSON) format.

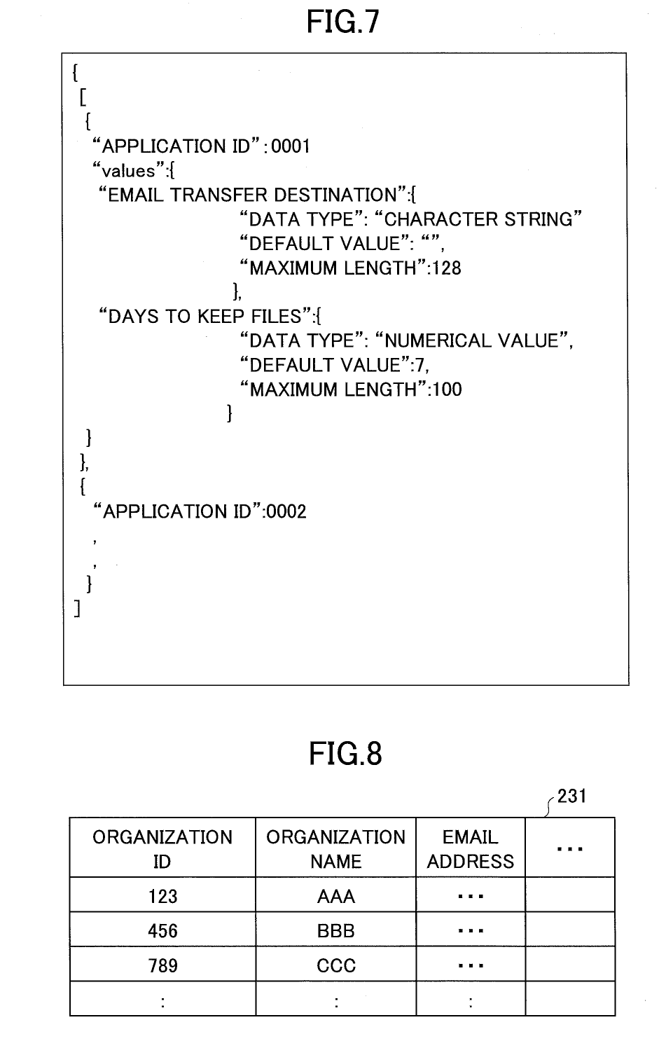

FIG. 7 is a diagram illustrating a configuration of a proper setting item information storage part in JSON format. In FIG. 7, the same definitions as in FIG. 6 are written in JSON format. Referring to FIG. 7, a maximum length is included in the attributes of each proper setting item for convenience purposes. The proper setting item information storage part 233 may be configured in other format such as Extensible Markup Language (XML) format.

Next, at step S104, the setting data generation part 225 determines the setting item names of the common setting items. The common setting items are basically fixed. Accordingly, the setting item names of the common setting items may be incorporated in the setting data generation part 225 as a logic. Alternatively, a storage part similar to the proper setting item information storage part 233 may be prepared for the common setting items. In this case, the setting data generation part 225 may determine the setting item names of the common setting items by referring to the storage part.

According to this embodiment, the user information storage part 231 that stores user information composed of the common setting items has a configuration as illustrated in FIG. 8, for example.

FIG. 8 is a diagram illustrating a configuration of a user information storage part. Referring to FIG. 8, the user information storage part 231 stores the values of items such as an organization ID, an organization name, and an electronic mail (email) address for each organization. The organization name is the name of an organization. The email address is, for example, the main email address of the organization. That is, according to this embodiment, the organization ID, the organization name, and the email address are the common setting items.

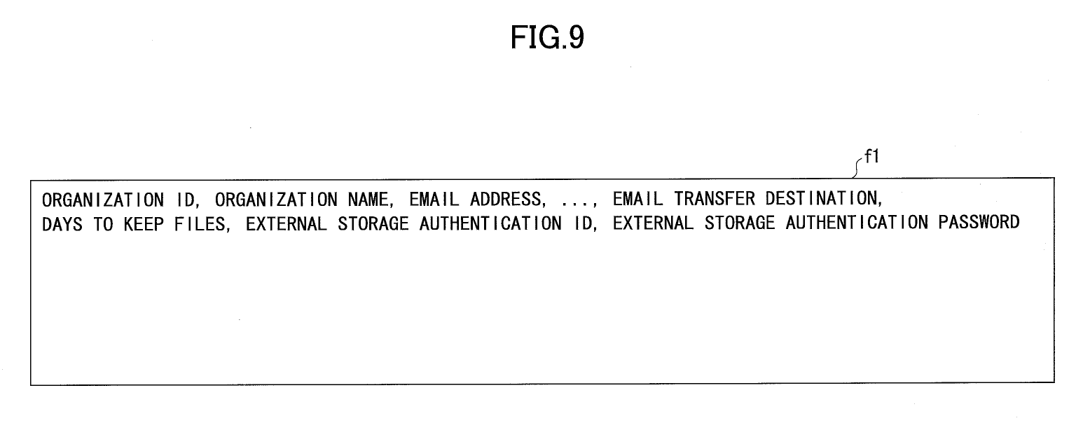

Next, at step S105, the setting data generation part 225 generates setting data for causing setting values to be set for the proper setting items whose setting item names have been determined at step S103 and the common setting items whose setting item names have been determined at step S104. According to the first embodiment, a file for causing setting values to be written is generated as setting data. For example, if the file is in CSV (Comma-Separated Values) format, a CSV file as illustrated in FIG. 9 is generated as setting data.

FIG. 9 is a diagram illustrating an example of a CSV file as setting data. In a CSV file f1 illustrated in FIG. 9, the proper setting item names and the common setting item names are written in the first line, being separated by commas. The first line serves as a guide for a user. That is, it is possible for a user to understand setting items whose values are to be written and the order in which the values are to be written by referring to the first line. Values for the setting items are written in the second line. In the case of providing different setting values for two or more individual users belonging to the same organization, setting values may be written user by user in the second and subsequent lines. In this case, the user information may include, for example, an item for identifying each individual user (for example, a username or the like).

The CSV file f1 illustrated in FIG. 9 is an example of setting data that are returned in response to the setting data obtaining request in which “123” is specified as the organization ID. The purchased applications of the organization related to the organization ID are the application A 211 and the application B 212. Therefore, the CSV file f1 does not include proper setting items related to the application C 213.

The proper setting item names included in the first line are the proper setting item names determined at step S103, that is, proper setting item names related to one or more of the server applications 210 for which a user has purchased a license. Accordingly, it is possible for a user to understand minimum required setting items for which the user is to set values.

When there is an overlap between the proper setting items of applications or between the proper setting items and the common setting items, the overlapping setting item(s) may be removed or excluded from setting data to be generated. For example, when the setting item names of the common setting items are a, b and c and the setting item names of the common setting items are b, d and e, the setting item b is an overlap. In this case, the setting items that are provided in setting data may be a, b, c, d and e in place of a, b, c, b, d and e. Alternatively, an overlap may be allowed and setting data may be so generated as to cause a setting value to be input for each of the common setting items and the proper setting items of each server application 210.

Next, at step S106, the setting data generation part 225 returns the generated CSV file f1 to the manager terminal 30, which has requested to obtain setting data.

A user writes the values of the setting items in the second and subsequent lines in the CSV file f1 at, for example, the manager terminal 30. The format of setting data is not limited to a CSV file, and may be, for example, XML format or other format.

Next, a description is given of a process that the service providing apparatus 20 executes in response to receiving setting data (CSV file) in which setting values are written from the manager terminal 30.

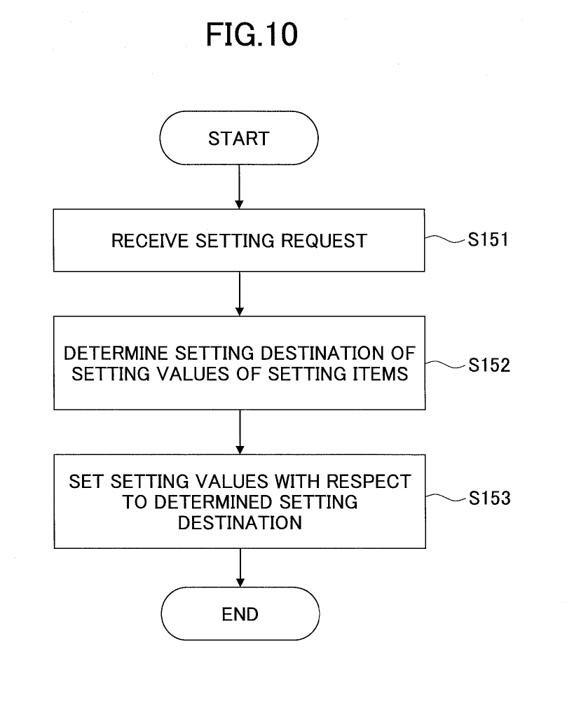

FIG. 10 is a flowchart for illustrating a procedure for a process of setting setting values for the common setting items and the proper setting items.

Referring to FIG. 10, at step S151, the setting recording part 221 receives a request to set setting values (a setting request). The setting request is transmitted from, for example, the manager terminal 30. Furthermore, in the setting request, setting values input to setting data are specified in correlation with the setting item names. For example, when the setting data are a CSV file, a CSV file is received in which setting values are written in the second line, being separated by commas, in order corresponding to the setting item names written in the first line.

Next, at step S152, the setting recording part 221 determines setting destinations for which the setting values for the setting items are to be set. Regarding the proper setting items, the setting recording part 221 specifies the application ID of a server application 210 that is a setting destination, referring to the proper setting item information storage part 233 using the setting item names as a key. Regarding the common setting items, the setting destination of each common setting item may be incorporated in the setting recording part 221 as a logic. Furthermore, when a storage part similar to the proper setting item information storage part 233 is prepared for the common setting items, the setting destination may be determined based on the storage part. According to this embodiment, there is a single setting destination (the user information storage part 231) for the setting values of the common setting items. Alternatively, the setting destination of the setting values of the common setting items may be distributed among multiple storage parts or programs.

Next, at step S153, the setting recording part 221 sets the setting values with respect to the determined setting destinations. At this point, with respect to a proper setting time for which no setting value is provided, a default value stored in the proper setting item information storage part 233 is set.

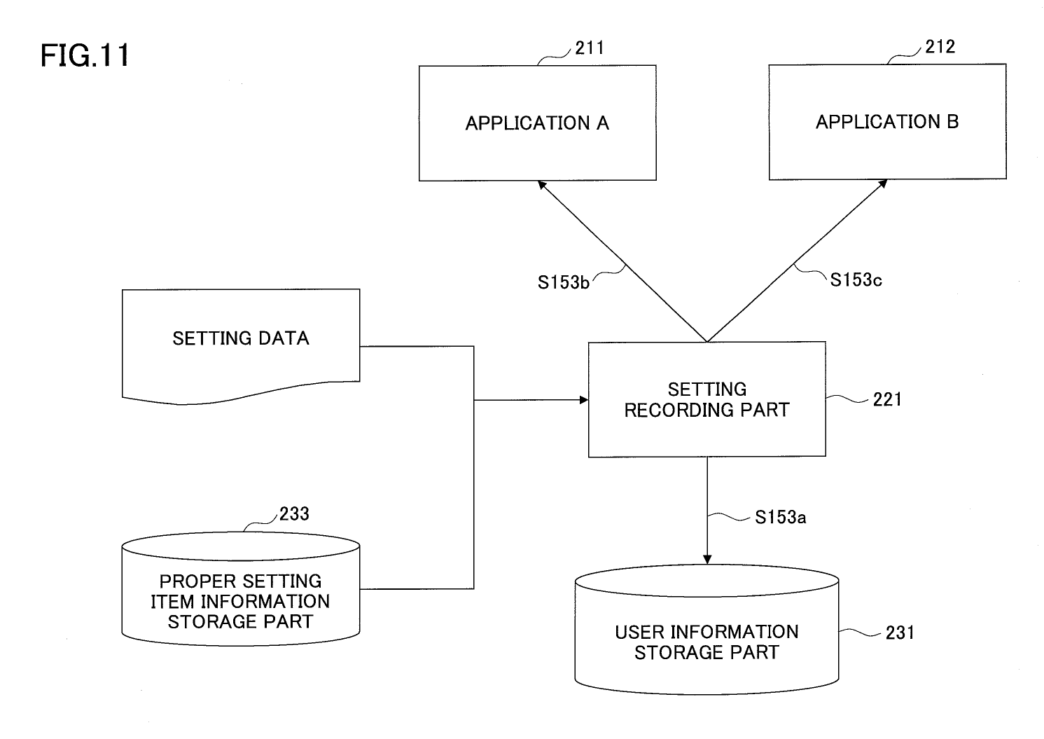

FIG. 11 is a diagram illustrating a process of setting setting values by a setting recording part.

For example, when setting values are written to setting data of a CSV file as illustrated in FIG. 9, at step S153a, the setting recording part 221 sets setting values for the organization ID, the organization name, and the email address in the user information storage part 231. That the setting values for an organization ID, an organization name, and an email address are to be set in the user information storage part 231 may be incorporated in the setting recording part 221 as a logic or determined based on a storage part regarding the common setting items, similar to the proper setting item information storage part 233.

Furthermore, the setting recording part 221 determines, based on the proper setting item information storage part 233, that a setting destination for the setting values for the email transfer destination and the days to keep files is the application A 211 whose application ID is “0001.” Then, at step S153b, the setting recording part 221 sets these setting values with respect to the application A 211.

Furthermore, the setting recording part 221 determines, based on the proper setting item information storage part 233, that a setting destination for the setting values for the external storage authentication ID and the external storage authentication password is the application B 212 whose application ID is “0002.” Then, at step S153c, the setting recording part 221 sets these setting values with respect to the application B 212.

The server applications 210 may be provided with an API such as a common function or method for receiving the settings of setting values. The setting recording part 221 may set setting values for the proper setting items via the API with respect to each server application 210. The setting values for the proper setting items of each server application 210 are stored in, for example, a storage unit of a computer on which each server application 210 runs.

As described above, according to the first embodiment, with respect to the proper setting items, setting items for one or more of the server applications 210 used by a user alone are presented as objects (targets) of setting in setting data. Accordingly, it is possible to simplify the operation of setting setting values with respect to each server application 210. For example, it is also possible to set setting values for the proper setting items of each server application 210 and the common setting items in a single setting operation. As a result, it is possible to reduce the operational load of setting values for setting items.

Next, a description is given of a second embodiment. In the second embodiment, a description is given of differences from the first embodiment. Accordingly, the second embodiment may be equal to the first embodiment with respect to elements or configurations not described in particular.

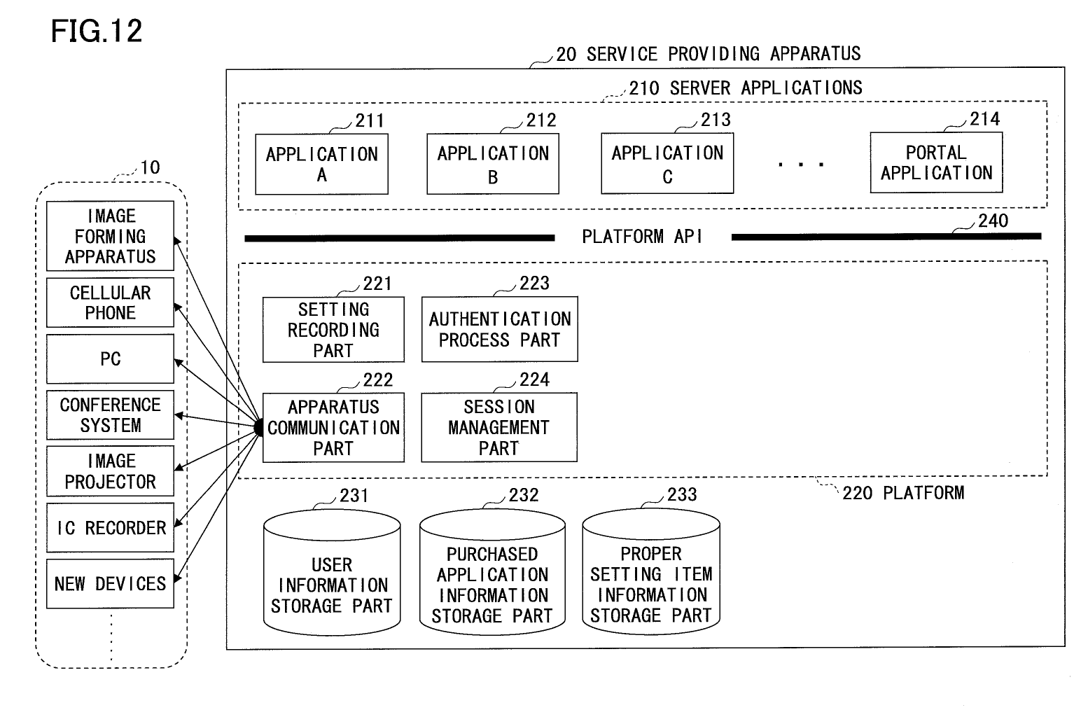

FIG. 12 is a diagram illustrating a functional configuration of a service providing apparatus according to the second embodiment. A difference between FIG. 12 and FIG. 3 lies in that the service providing apparatus 20 of FIG. 12 does not include the setting data generation part 225. This is because according to the second embodiment, the portal application 214 implements the function of the setting data generation part 225 instead.

Therefore, according to the second embodiment, the process illustrated in FIG. 4 is executed by the portal application 214. Basically, the contents of the process of each of steps S101 through S106 of FIG. 4 may be the same as in the first embodiment. According to the second embodiment, however, screen data for causing a screen to be displayed, where the screen is for causing setting values to be set, are generated as setting data. The screen data may be in, for example, universal format such as HTML (Hypertext Markup Language) format or other data format.

At step S106 (FIG. 4), the generated screen data are returned to the manager terminal 30. The manager terminal 30 causes a setting screen to be displayed based on the screen data.

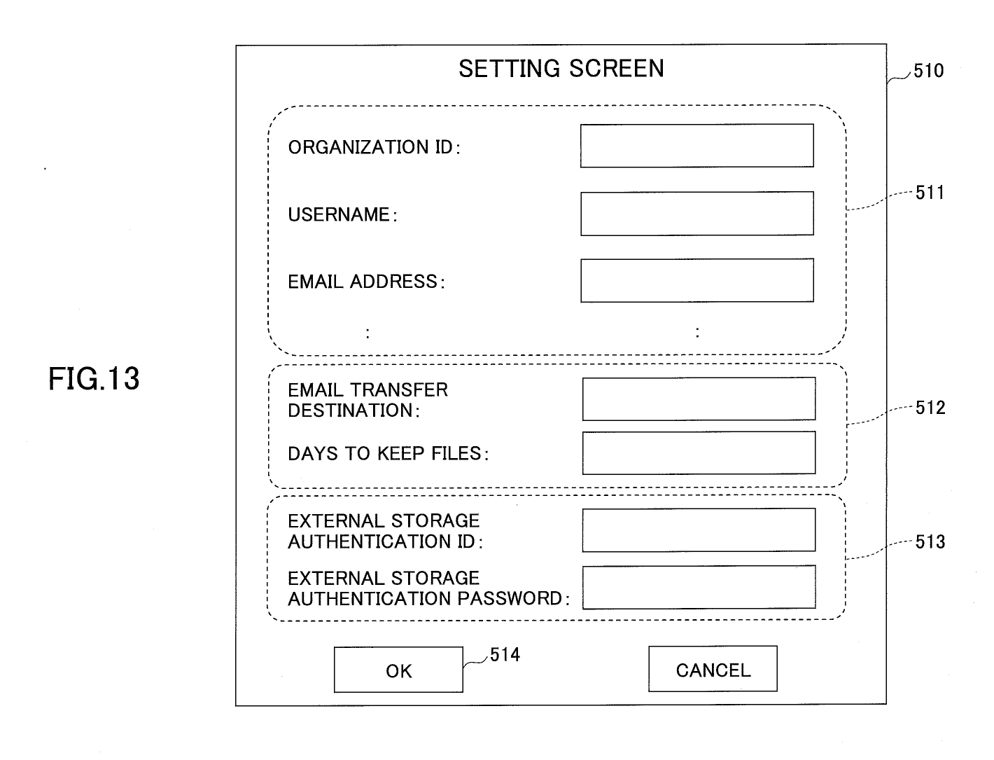

FIG. 13 is a diagram illustrating example display of a setting screen. Setting items that are made objects of setting in a setting screen 510 illustrated in FIG. 13 are equal to those in the CSV file f1 illustrated in FIG. 9. That is, an area 511 is a setting area for the common setting items. An area 512 is a setting area for the proper setting items of the application A 211 whose application ID is “0001.” An area 513 is a setting area for the proper setting items of the application B 212 whose application ID is “0002.”

The setting screen 510 illustrated in FIG. 13 is an example of the setting data returned in response to the setting data obtaining request in which “123” is specified as the organization ID. The purchased applications of the organization related to the organization ID are the application A 211 and the application B 212. Therefore, the setting screen 510 does not include proper setting items related to the application C 213.

In the case of using screen data as the setting data as well, an overlap between setting items may be removed or excluded the same as in the first embodiment.

On the other hand, when it is desirable to clearly separate display areas for setting items for the common setting items and the individual server applications 210, the common setting items and the individual server applications 210 may be assigned respective tabs.

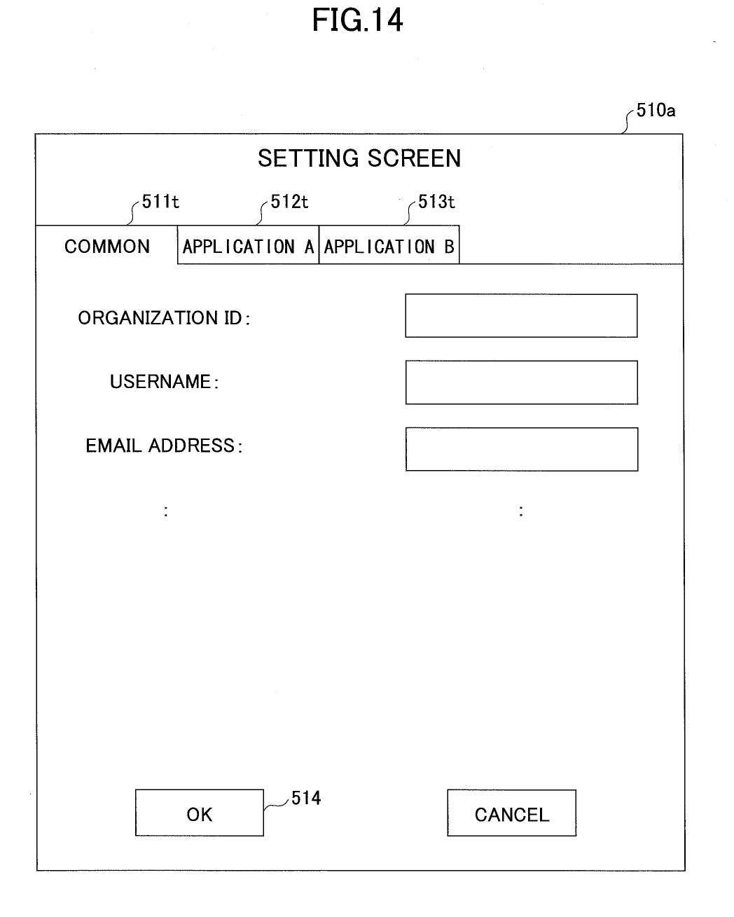

FIG. 14 is a diagram illustrating first example display of a setting screen 510a, where the common setting items and individual server applications are assigned respective tabs. FIG. 14 illustrates a case where the common setting items are assigned to a tab 511t, the proper setting items of the application A 211 are assigned to a tab 512t, and the proper setting items of the application B 212 are assigned to a tab 513t. According to this configuration, it is possible to prevent the setting screen 510 from being extremely long or prevent the scale of a scroll bar from being extremely large. In the case illustrated in FIG. 14, the tab 511t is selected and the common setting items are displayed.

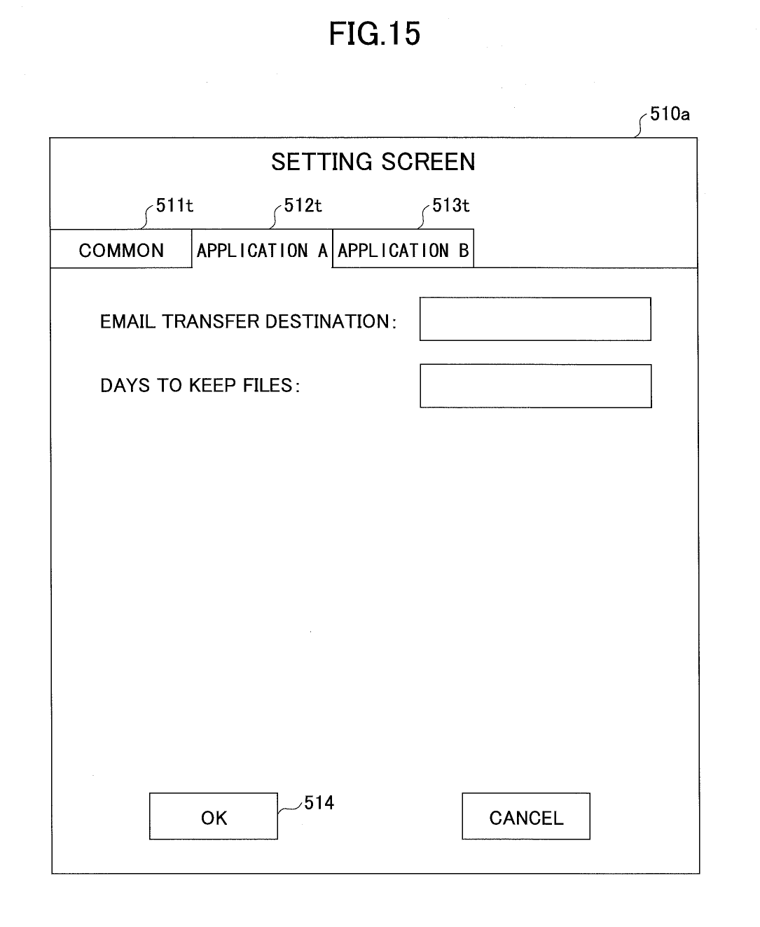

FIG. 15 is a diagram illustrating second example display of the setting screen 510a, where the common setting items and individual server applications are assigned respective tabs. FIG. 15 illustrates a case where the tab 512t is selected and the proper setting items of the application A 211 are displayed.

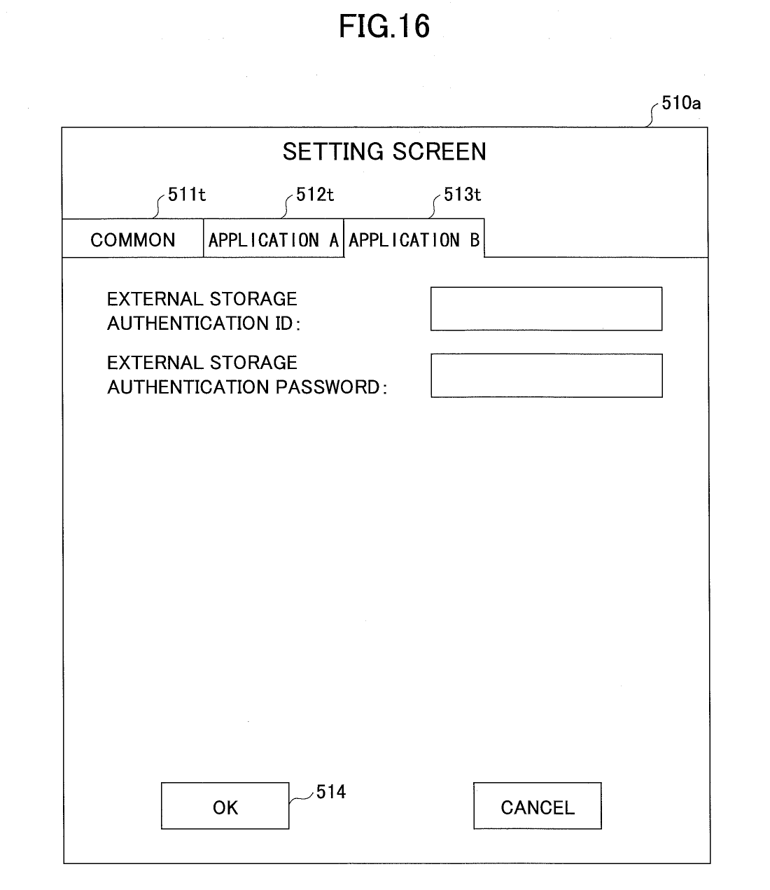

Furthermore, FIG. 16 is a diagram illustrating third example display of the setting screen 510a, where the common setting items and individual server applications are assigned respective tabs. FIG. 16 illustrates a case where the tab 513t is selected and the proper setting items of the application B 212 are displayed.

The setting screen 510a illustrated in FIG. 14 through FIG. 16 is an example of the setting data returned in response to the setting data obtaining request in which “123” is specified as the organization ID. The purchased applications of the organization related to the organization ID are the application A 211 and the application B 212. Therefore, the setting screen 510a does not include a tab for the application C 213.

When setting values for the setting items are entered and an OK button 514 is depressed on the setting screen 510 or 510a, the manager terminal 30 transmits a setting request in which the setting values entered on the setting screen 510 or 510a are specified in correlation with the setting item names to the service providing apparatus 20. In response to receiving the setting request, the portal application 214 executes the same procedure as that for the process illustrated with reference to FIG. 10. The portal application 214, however, may not execute all the steps S151 through S153 of FIG. 10. For example, the portal application 214 may only input the information specified in the setting request in the setting recording part 221. The setting recording part 221 may execute the steps S151 through S153 of FIG. 10 in response to the inputting of the information.

As described above, according to the second embodiment, it is possible to provide a setting part for the common setting items and the proper setting items using a graphical user interface (GUI).

Next, a description is given of a third embodiment. In the third embodiment, a description is given of differences from the second embodiment. Accordingly, the third embodiment may be equal to the second embodiment with respect to elements or configurations not described in particular.

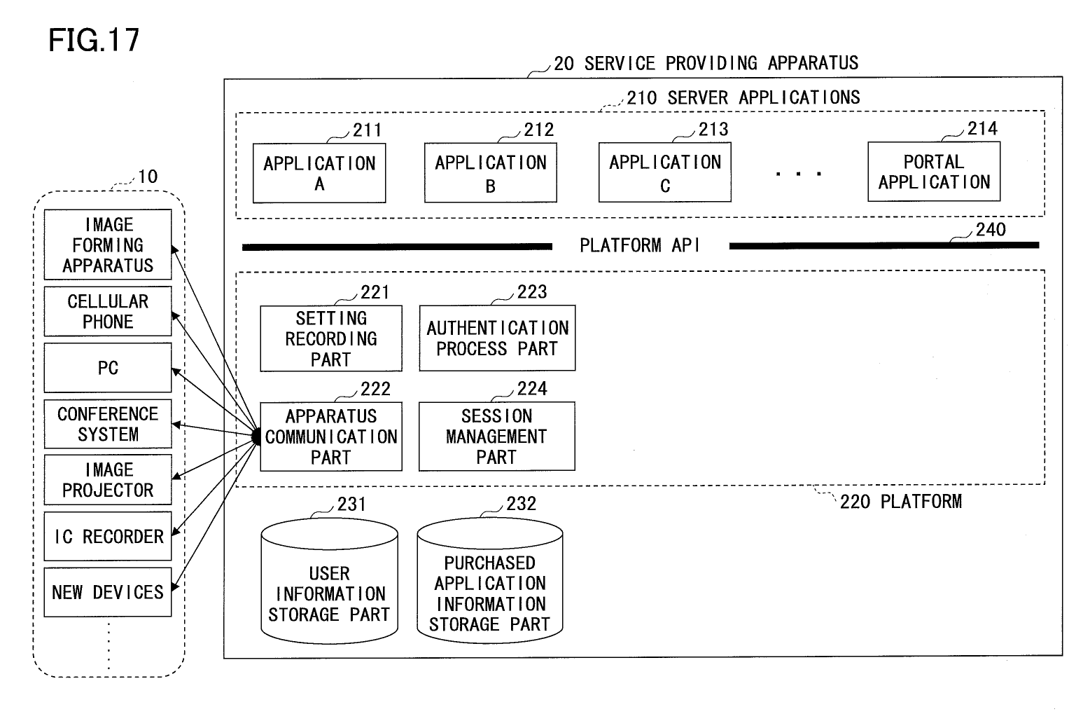

FIG. 17 is a diagram illustrating a functional configuration of a service providing apparatus according to the third embodiment. A difference between FIG. 17 and FIG. 12 lies in that the service providing apparatus 20 of FIG. 17 does not include the proper setting item information storage part 233. This is because according to the third embodiment, the information stored in the proper setting item information storage part 233 is implemented as a logic inside a program module (hereinafter referred to as “setting program”) that is plugged into the portal application 214 with respect to each server application 210.

That is, the server application A 211, the server application B 212, and the server application C 213 have their respective corresponding setting programs. For example, the setting programs may be plugged into the portal application 214 at the time of the installation of the corresponding server applications 210. Furthermore, a setting program corresponding to the common setting items also is plugged into the portal application 214. Each setting program includes the function of displaying a screen for causing settings to be provided for a server application 210 corresponding to the setting program or the common setting items and the function of setting setting values provided through the screen. Portlets are suitable as the setting programs. The portlets may cause the respective windows of the corresponding tabs 511t through 513t illustrated in FIG. 14 to be displayed.

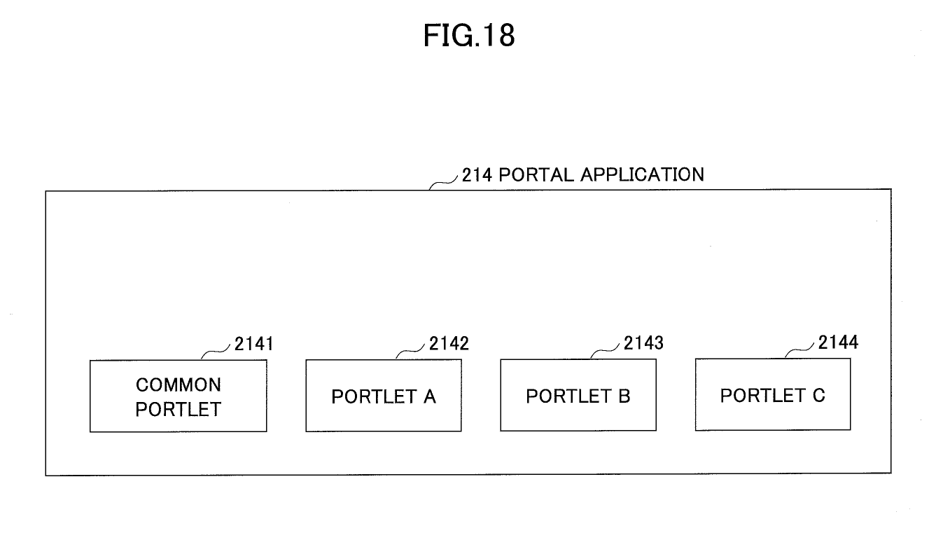

FIG. 18 is a diagram illustrating an example of the plugging of portlets into a portal application. FIG. 18 illustrates a case where a common portlet 2141, a portlet A 2142, a portlet B 2143, and a portlet C 2144 are plugged into the portal application 214.

The common portlet 2141 is a portlet corresponding to the common setting items. The portlet A 2142, the portlet B 2143, and the portlet C 2144 are portlets corresponding to the application A 211, the application B 212, and the application C 213, respectively. Accordingly, the common portlet 2141 generates the window corresponding to the tab 511t illustrated in FIG. 14 and sets setting values for the common setting items. The portlet A 2142 generates the window corresponding to the tab 512t illustrated in FIG. 15 and sets setting values for the proper setting items of the application A 211. The portlet B 2143 generates the window corresponding to the tab 513t illustrated in FIG. 16 and sets setting values for the proper setting items of the application B 212.

Each of the portlets 2141 through 2144 is implemented as, for example, a file of Web Application Archive (WAR) format. For example, the WAR files of the portlets 2141 through 2144 are stored in a predetermined folder, so that the portlets 2141 through 2144 are plugged into the portal application 214. That is, the portal application 214 is so implemented as to recognize a WAR file stored in a predetermined folder as a plug-in object.

A basic procedure for a process executed by the portal application 214 may be the same as described with reference to FIG. 4 and FIG. 10. A process corresponding to the common setting items and a process corresponding to the proper setting items of each server application 210, however, are executed by corresponding setting programs (for example, portlets).

Specifically, when the OK button 514 of the setting screen 510a is depressed in one of the states of FIG. 14 through FIG. 16, a request to set setting values (a setting request) including a uniform resource locator (URL) corresponding to the window displayed on the setting screen 510a is transmitted to the portal application 214. In response to receiving the setting request, the portal application 214 inputs the setting request to a portlet corresponding to the URL included in the setting request. For example, the setting request in the state where the tab 511t is selected is input to the common portlet 2141. The setting request in the state where the tab 512t is selected is input to the portlet A 2142. The setting request in the state where the tab 513t is selected is input to the portlet B 2143.

Each portlet to which the setting request has been input executes a process of setting the setting values included in the setting request. Specifically, the common portlet 2141 records the setting values of the common setting items in the user information storage part 231. The portlet A 2142 transmits the setting values of the proper setting items of the application A 211 to the application A 211. The portlet B 2143 transmits the setting values of the proper setting items of the application B 212 to the application B 212. In response to receiving the setting values of the proper setting items, each of the application A 211 and the application B 212 stores the received setting values in a storage unit of a computer on which the application A 211 or the application B 212 runs.

The setting of user information is taken as an example in the above description of embodiments. The object of setting, however, is not limited to user information, and embodiments of the present invention may also be applied to, for example, the setting of information on an organization-wide basis or the setting of apparatus information. In this case, the organization ID is used as the identification information of an organization, or the organization ID, which is identification information as an apparatus with respect to an organization, is used as the identification information of the apparatus. Accordingly, embodiments of the present invention may be applied irrespective of whether to set user information, apparatus information, information on an organization basis, or other information. The setting of a rule to perform forced duplex printing on an organization-wide basis in a print service and a setting to specify the number of pages of data to be projected on a single screen in accordance with the capability of an apparatus (an image projector) in a projection service are taken as examples.

According to an aspect of the present invention, adding server applications 210 that provide services using the functions of the platform 220 suitably to the service providing apparatus 20 makes it possible for the service providing apparatus 20 to provide a wide variety of services, and upgrading the server applications 210 makes it possible for the service providing apparatus 20 to provide additional functions with respect to the services. The service providing apparatus 20 includes the function of recording common setting information such as user information that may be shared by the server applications 210 and the function of recording proper setting item information regarding settings proper to the server applications 210, which settings are properly retained by the server applications 210 as desired. Then, by providing a user (such as a manager) who desires to record (register) setting information with setting data generated from setting items of common setting information (common setting items) and setting items based on a service (server application 210) identified by identification information (organization ID) (proper setting items), setting items suitable for the user may be provided. This makes it possible for a user to appropriately and efficiently register setting information, and makes it possible for the server applications 210 to have proper setting information specific to their respective services and flexibly register proper setting items (add and delete items) as required.

In the above-described embodiments, the service providing apparatus 20 is an example of an apparatus or system for providing assistance in configuring settings. The setting data generation part 225 or a setting program is an example of an obtaining part, a generation part, and a returning part. The setting recording part 221 or a setting program is an example of a setting part. The purchased application information storage part 232 is an example of a first storage part. The proper setting item information storage part 233 is an example of a second storage part. The application ID is an example of program identification information. The organization ID is an example of identification information pertaining to a requestor of an input request to input a value for a setting item of a program.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A setting support apparatus, comprising:
an obtaining part configured to obtain, in response to an input request to input a value for a setting item of a program, program identification information of the program stored in correlation with identification information pertaining to a requestor of the input request in a first storage part;
a generation part configured to generate data for causing the value to be input for the setting item of the program related to the obtained program identification information; and
a returning part configured to return the generated data to the requestor of the input request.

2. The setting support apparatus as claimed in claim 1, further comprising:
a setting part configured to set the value with respect to the program having the setting item, with respect to the setting item for which the value has been provided based on the generated data.

3. The setting support apparatus as claimed in claim 2, wherein the setting part is configured to specify the program having the setting item with respect to the setting item for which the value has been provided based on the generated data, referring to a second storage part that stores information indicating the setting item of the program pertaining to the program identification information in correlation with the program identification information, and to set the value for the setting item with respect to the specified program.

4. The setting support apparatus as claimed in claim 1, wherein the generation part is configured to specify the setting item of the program pertaining to the obtained program identification information, referring to a second storage part that stores information indicating the setting item of the program pertaining to the program identification information in correlation with the program identification information, and to generate the data for causing the value to be input for the specified setting item.

5. The setting support apparatus as claimed in claim 1, wherein the data are a file for causing the value to be input.

6. The setting support apparatus as claimed in claim 1, wherein the data are screen data for causing a screen for causing the value to be input to be displayed.

7. A setting support system including a computer, the setting support system comprising:
an obtaining part configured to obtain, in response to an input request to input a value for a setting item of a program, program identification information of the program stored in correlation with identification information pertaining to a requestor of the input request in a first storage part;
a generation part configured to generate data for causing the value to be input for the setting item of the program related to the obtained program identification information; and
a returning part configured to return the generated data to the requestor of the input request.

8. The setting support system as claimed in claim 7, further comprising:
a setting part configured to set the value with respect to the program having the setting item, with respect to the setting item for which the value has been provided based on the generated data.

9. The setting support system as claimed in claim 8, wherein the setting part is configured to specify the program having the setting item with respect to the setting item for which the value has been provided based on the generated data, referring to a second storage part that stores information indicating the setting item of the program pertaining to the program identification information in correlation with the program identification information, and to set the value for the setting item with respect to the specified program.

10. The setting support system as claimed in claim 7, wherein the generation part is configured to specify the setting item of the program pertaining to the obtained program identification information, referring to a second storage part that stores information indicating the setting item of the program pertaining to the program identification information in correlation with the program identification information, and to generate the data for causing the value to be input for the specified setting item.

11. The setting support system as claimed in claim 7, wherein the data are a file for causing the value to be input.

12. The setting support system as claimed in claim 7, wherein the data are screen data for causing a screen for causing the value to be input to be displayed.

13. A setting support method, comprising:
obtaining, by a computer, in response to an input request to input a value for a setting item of a program, program identification information of the program stored in correlation with identification information pertaining to a requester of the input request in a first storage part;
generating, by the computer, data for causing the value to be input for the setting item of the program related to the obtained program identification information; and
returning, by the computer, the generated data to the requestor of the input request.
